(19) United States
(12) Patent Application Publication
(10) Pub. No.: US 2007/0165614 A1
(43) Pub. Date: Jul. 19, 2007

(54) Apparatus capable of running primary and secondary processes

(75) Inventor: Daisuke Kimura, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: KABUSHIKI KAISHA TOSHIBA, Tokyo (JP)

(21) Appl. No.: 11/484,160

(22) Filed: Jul. 11, 2006

(30) Foreign Application Priority Data
Jan. 13, 2006 (JP) 2006-006338

(51) Int. Cl. H04L 12/66

(52) U.S. Cl. 370/356

(57) ABSTRACT

A communication apparatus capable of running a secondary process in addition to a primary process of communication is provided. The communication apparatus includes a communication circuit configured to send and receive a plurality of signals for communication, includes a first controller coupled to the communication circuit and configured to run the primary process using the communication circuit, and includes a second controller configured to run the secondary process. The communication apparatus includes a display, and includes a display controller coupled to the first controller, the second controller and the display. The display controller is configured to receive a piece of information regarding operation of the second controller from the second controller. The display controller is configured to present a given screen on the display including the information received from the second controller. The display controller is configured to pause if the first controller starts running the primary process.

### CROSS REFERENCE TO RELATED APPLICATIONS

This application is based upon and claims the benefit of priority from the prior Japanese Patent Application No. 2006-006338 filed on Jan. 13, 2006; the entire contents of which are incorporated herein by reference.

### FIELD OF THE INVENTION

The present invention relates to an apparatus capable of running a secondary process in addition to a primary process of communication, and in particular to an apparatus usable for communications.

### DESCRIPTION OF THE BACKGROUND

Disclosed are a method for storing a plurality of pieces of music content in a memory of a mobile communication apparatus, and a method for presenting a title and a playing time of one of the pieces of music that is being played on a display of the mobile communication apparatus, in Japanese Patent Publication (Kokai), No. 2002-123273.

A communication apparatus including a mobile communication apparatus may be capable of running a secondary process, e.g. playing a piece of music, in addition to a primary process of communication. The primary process should run smoothly while preceding the secondary process, and should not be disturbed by the secondary process. The above mentioned methods, however, do not clarify how to run a primary process, e.g. of mobile communications smoothly, while running a secondary process, e.g. of playing a piece of music.

### SUMMARY OF THE INVENTION

Accordingly, an advantage of the present invention is that a communication apparatus may run a primary process and a secondary process in a flexible manner.

To achieve the above advantage, one aspect of the present invention is to provide a communication apparatus capable of running a secondary process in addition to a primary process of communication. The communication apparatus includes a communication circuit configured to send and receive a plurality of signals for communication, includes a first controller coupled to the communication circuit and configured to run the primary process using the communication circuit, and includes a second controller configured to run the secondary process. The communication apparatus includes a display, and includes a display controller coupled to the first controller, the second controller and the display. The display controller is configured to receive a piece of information regarding operation of the second controller from the second controller. The display controller is configured to present a given screen on the display including the information received from the second controller. The display controller is configured to pause if the first controller starts running the primary process.

### BRIEF DESCRIPTION OF THE DRAWINGS

FIG. 1 is a block diagram of a mobile communication apparatus of a first embodiment of the present invention.

FIG. 2 shows an example of image content data of the first embodiment of the present invention.

FIG. 3 shows an example of a first type of music content data of the first embodiment of the present invention.

FIG. 4 shows an example of a second type of music content data of the first embodiment of the present invention.

FIG. 5 is a flow chart of a method for running a primary process and a secondary process of the first embodiment of the present invention.

FIG. 6 shows an example of an idle screen of the first embodiment of the present invention.

FIG. 7 shows an example of a screen indicating music information after starting music of the first embodiment of the present invention.

FIG. 8 shows a first example of the idle screen indicating music information and status information of the first embodiment of the present invention.

FIG. 9 shows a second example of the idle screen indicating music information and status information of the first embodiment of the present invention.

FIG. 10 shows a third example of the idle screen indicating music information and status information of the first embodiment of the present invention.

FIG. 11 shows a fourth example of the idle screen indicating music information and status information of the first embodiment of the present invention.

FIG. 12 is a flow chart of a method for running a primary process and a secondary process of a second embodiment of the present invention.

### DETAILED DESCRIPTION OF THE INVENTION

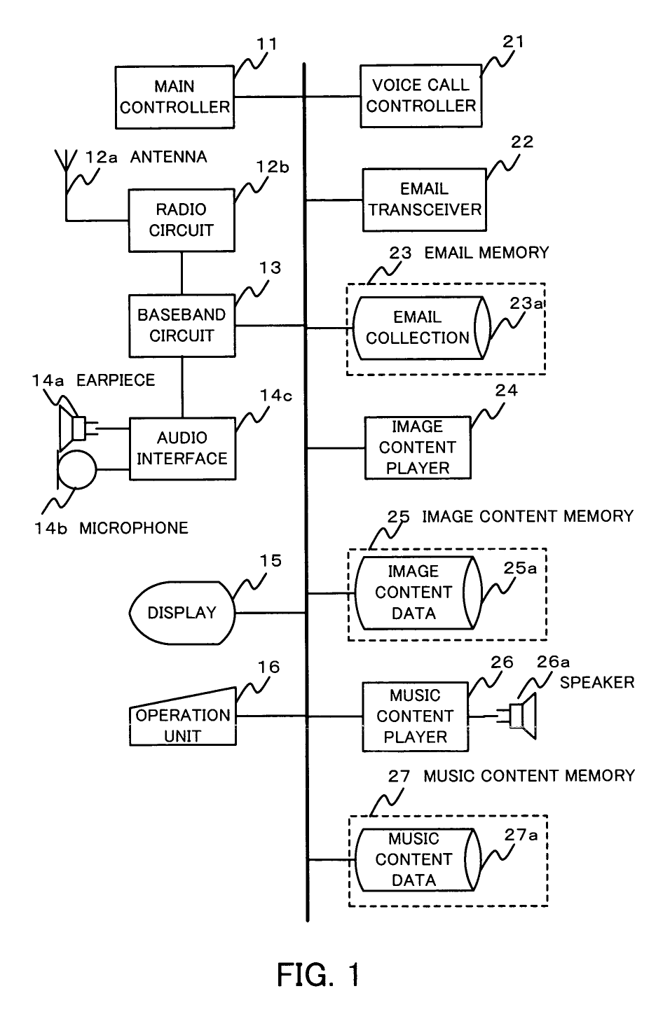

A first embodiment of the present invention will be described with reference to FIGS. 1-11. FIG. 1 is a block diagram of a mobile communication apparatus of the present invention. The mobile communication apparatus of the present invention includes a main controller 11 configured to control each portion and a whole of the mobile communication apparatus of the present invention. The mobile communication apparatus of the present invention includes an antenna 12a and a radio circuit 12b, both configured to send and receive a plurality of radio signals to and from a base station of a mobile network (not shown), and includes a baseband circuit 13.

The mobile communication apparatus of the present invention includes an earpiece 14a, a microphone 14b and an audio interface 14c, for a voice call. The mobile communication apparatus of the present invention includes a display 15, an operation unit 16, a voice call controller 21, an email transceiver 22 and an email memory 23. The mobile communication apparatus of the present invention includes an image content player 24, an image content memory 25, a music content player 26, a speaker 26a for producing a music sound, and a music content memory 27.

The email memory 23 is configured to store an email collection 23a. The image content memory 25 is configured to store a plurality of image content data 25a including a plurality of static pictures and a plurality of moving pictures. The image content data 25a will be explained later in detail. The music content memory 27 is configured to store a plurality of music content data 27a

An operation of each portion of the mobile communication apparatus listed above will be described with reference to FIG. 1. The radio circuit 12b is configured to provide the baseband circuit 13 with an incoming radio frequency signal received by the antenna 12a, and to transmit an outgoing radio frequency signal via the antenna 12a.

The baseband circuit 13 is configured to amplify, down-convert and demodulate the incoming radio frequency signal provided by the radio circuit 12b, and to produce one of an incoming digital voice signal and an incoming control signal. The baseband circuit 13 is configured to provide the audio interface 14c with the incoming digital voice signal, and provides the main controller 11 with the incoming control signal.

The baseband circuit 13 is configured to modulate, up-convert and amplify a frequency carrying one of an outgoing control signal provided by the main controller 11 and an outgoing digital voice signal provided by the audio interface 14c, so as to produce the outgoing radio frequency signal. The baseband circuit 13 is configured to provide the radio circuit 12b with the outgoing radio frequency signal.

The audio interface 14c is configured to convert the incoming digital voice signal into an incoming analog voice signal. The audio interface 14c is configured to amplify the incoming analog voice signal and to provide the earpiece 14a with the incoming analog voice signal. The audio interface 14c is configured to amplify an outgoing analog voice signal provided by the microphone 14b, to convert the outgoing analog voice signal into the outgoing digital voice signal, and to provide the baseband circuit 13 with the outgoing digital voice signal.

The display 15 has a front screen (a front surface) disposed on a face of the mobile communication apparatus of the present invention, and is configured to present a cursor, a plurality of pieces of text formed by characters, numerals, etc., and a plurality of images on the front screen under control of the main controller 11. The text and the images presented on the display 15 may alter under control of the main controller 11 in response to an operation on the operation unit 16, an incoming control signal, etc.

The operation unit 16 includes a plurality of numeric keys each of which may toggle a numeral and a couple of characters. The operation unit 16 includes a navigation key usable for moving the cursor up, down, left or right. The operation unit 16 includes a plurality of soft keys each of which may be assigned a specific function. If one of the keys is pressed, the operation unit 16 sends a signal identifying the pressed key to the main controller 11. Based on the above signal, the main controller 11 may present a numeral, a character, etc. on the display 15 and may control an operation of the mobile communication apparatus of the present invention.

The voice call controller 21 is configured to control a plurality of voice calls. In response to a key operation on the operation unit 16 to start a voice call, the main controller 11 activates the voice call controller 21. After being activated, the voice call controller 21 activates the radio circuit 12b, the baseband circuit 13 and the audio interface 14c. The voice call controller 21 is configured to run a process of requesting a call and a process of a voice transaction, while showing on the display 15 that the above mentioned processes are running.

If the baseband circuit 13 receives a signal indicating an arrival of a call request, the main controller 11 activates the voice call controller 21. After being activated and in response to an operation of at least one of the keys of the operation unit 16 assigned to accept a call request, the voice call controller 21 runs a process of accepting the call request and a process of a voice transaction, while showing on the display 15 that the above mentioned processes are running.

The voice call controller 21 is configured to stop working after an operation of at least one of the keys of the operation unit 16 assigned to end a voice call. As later described, the above mentioned processes of the voice call controller 21 are included in a plurality of primary processes of the mobile communication apparatus of the present invention. Each of the primary processes precedes each of a plurality of secondary processes of the mobile communication apparatus of the present invention.

The email transceiver 22 is configured to send and receive a plurality of emails. In response to an operation of at least one of the keys of the operation unit 16 assigned to send an outgoing email, the main controller 11 activates the email transceiver 22. After being activated, the email transceiver 22 prepares an outgoing email according to a key operation on the operation unit 16. The email transceiver 22 activates the radio circuit 12b and the baseband circuit 13 to send the prepared email.

After the baseband circuit 13 receives a signal indicating an arrival of an incoming email, the main controller 11 activates the email transceiver 22. After being activated, the email transceiver 22 receives the incoming email and includes the received email in the email collection 23a stored in the email memory 23.

In response to an operation of at least one of the keys of the operation unit 16 assigned to present an email, the main controller 11 activates the email transceiver 22. After being activated, the email transceiver 21 presents on the display 15 an email selected out of the email collection 23a stored in the email memory 23 according to a given key operation on the operation unit 16. As later described, the above mentioned processes of the email transceiver 22 are included in the primary processes.

The email transceiver 22 may deal with an email with an attached file. A data file included in the image content data 25a may be attached to an email to be transmitted. A data file included in the music content data 27a may be attached to an email to be transmitted.

If an email with an attached file is received, the email transceiver 22 may include the attached file in the image content data 25a stored in the image content memory 25, and may include the attached file in the music content data 27a stored in the music content memory 27, according to a kind of the attached file.

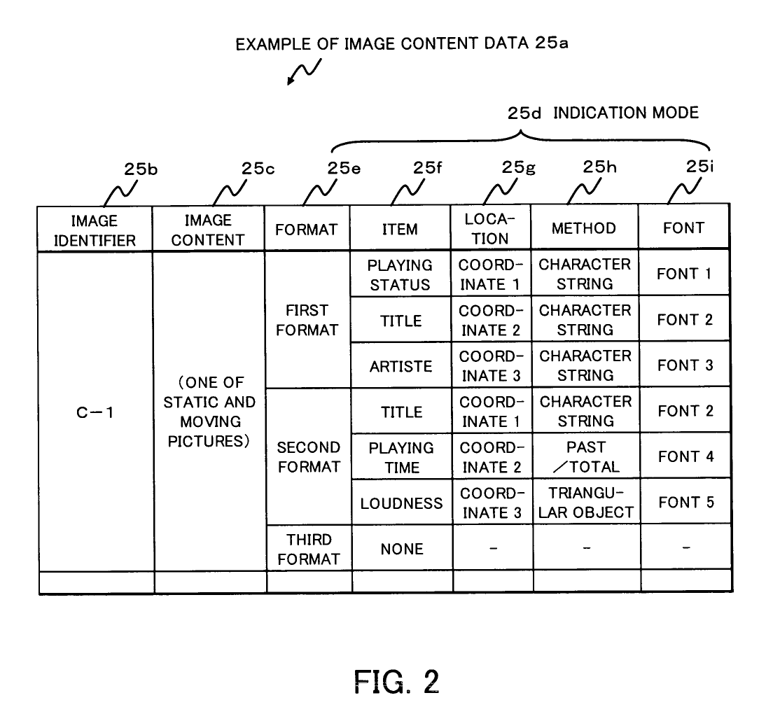

FIG. 2 shows an example of the image content data 25a formed by an image identifier 25b, an image content data block 25c (hereinafter called the image content 25c) and an indication mode 25d. The image identifier 25b identifies the image content 25c representing a piece of image content, i.e. one of a static picture and a series of moving pictures. The image content 25c may be stored as a data file being separate with the indication mode 25d, and a name of the data file may be stored in association with the image identifier 25b.

The indication mode 25d shows how to indicate a piece of information regarding operation of the music content player 26, i.e., regarding a piece of music that is being played (music information) and regarding a status of the music content player 26 (status information), which is provided by the music content player 26. The indication mode 25d is formed by a plurality of elements, i.e. a format 25e, an item 25f, a location 25g, a method 25h and a font 25i.

The format 25e defines an arrangement of each element of the indication mode 25d. The item 25f defines what is indicated out of the music information and the status information provided by the music content player 26. The location 25g defines a location on the front screen of the display 15 where the information defined by the item 25f is indicated. The method 25h defines how the information defined by the item 25f is indicated, i.e. by a character string, by an image object, etc. The font 25i defines a font type for indicating the information defined by the item 25f and indicated by a character string.

The image identifier 25b of the example of the image content data 25a shown in FIG. 2 is “C-1”. The format 25e is one of a first format, a second format and a third format. The first format has three entries for the item 25f, which are a playing status, a title and an artiste of a piece of music that is being played. The playing status is one of running, pausing, fast-forwarding and rewinding.

The second format has three entries for the item 25f, which are a title and a playing time of a piece of music that is being played and a level of loudness for playing the piece of music. An entry “PAST/TOTAL” of the method 25h corresponding to the item 25f being the playing time means that the playing time is indicated by a period of time counted from a beginning of the piece of music that is being played and a total playing time of the piece of music that is being played, which are separated by a slash with each other.

An entry “TRIANGULAR OBJECT” of the method 25h corresponding to the item 25f being the loudness means that the loudness is indicated by a triangular indicator divided into two portions each of which is distinguished, e.g. by a distinct color. The triangular indicator indicates a minimum level of loudness while being occupied by one of the two portions, and indicates a maximum level of loudness while being occupied by another of the two portions.

The third format has none for the item 25f. According to the third format, none of the music information of a piece of music that is being played and the status information of the music content player 26, both received form the music content player 26, is indicated on the display 15.

In addition, the indication mode 25d may define how to blink a character string, an image object, etc. for indicating the music information and the status information. The indication mode 25d may define in which language indicated are the music information and the status information having been sent from the music content player 26, e.g. in Japanese and English.

In response to an operation on the operation unit 16 to select the image identifier 25b, the main controller 11 activates the image content player 24. After being activated, the image content player 24 presents on the display 15 an idle screen (i.e. a page that appears on the front screen of the display 15 if the mobile communication apparatus of the present invention is ready to receive a call) formed by the image content 25c identified by the image identifier 25b.

The image content player 24 receives the music information and the status information from the music content player 26. The image content player 24 indicates the music information and the status information on the display 15 according to the format 25e corresponding to the image identifier 25b.

In a case where the image content 25c corresponding to the image identifier 25b represents a series of moving pictures, the indicated information may be poorly visible as the indicated information overlaps with a motion of the moving pictures. In such a case, the motion of the moving pictures may be stopped and a frame of the moving pictures, i.e. a static picture, may be presented on the display 15.

In a case where the format 25e is one of a plurality of formats as shown in FIG. 2, the image content player 24 may, but not limited to, indicate the music information and the status information according to each of the formats alternatively on a given time interval basis. The image content player 24 may indicate the music information and the status information according to, e.g. one of the formats of the indication format 25e selected by the main controller 11.

In a case where the image content 25c represents a series of moving picture (i.e. a movie), the image content player 24 may indicate the music information and the status information according to each of the formats of the format 25e alternately selected as the movie goes by. For each selection, one of the formats of the format 25e may be selected so that, e.g. the music information and the status information are indicated not in a central area but in a fringe area of the front screen of the display 15 where a spatial change of color appearance is gradual in order not to disturb visibility of the movie represented by the image content 25c.

As later explained, what the image content player 24 deals with as described above is one of the secondary processes. While one of the primary processes is running, a portion of the mobile communication apparatus of the present invention running that process may control presentation on the display 15, and the image content player 24 may pause without controlling presentation on the display 15. The above mentioned control of the presentation may be arranged so that the portion running that process uses a portion of the front screen of the display 15, and the image content player 24 uses another portion of the front screen of the display 15.

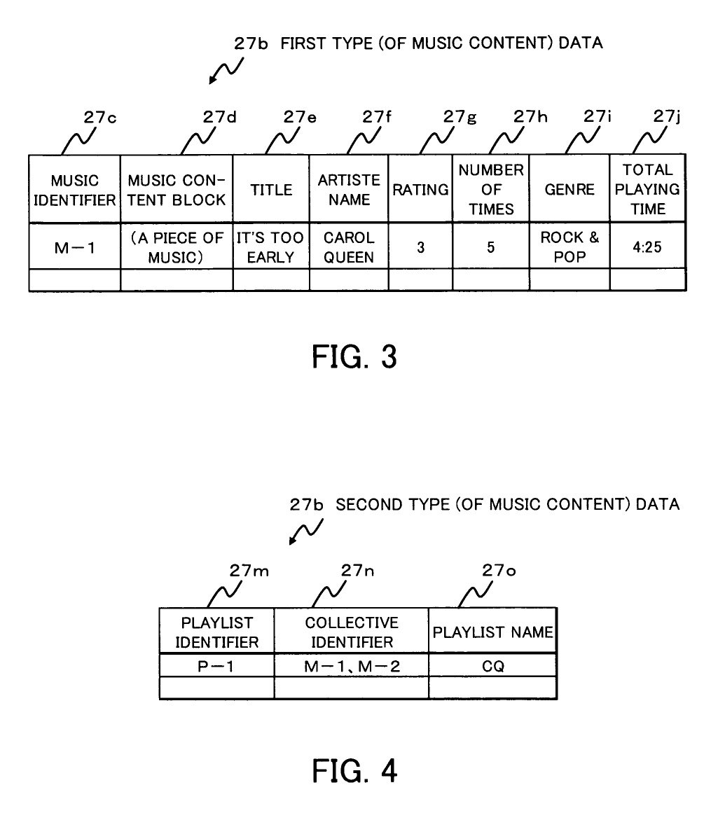

Each of the music content data 27a stored in the music content memory 27 is one of a first type of music content data 27b (hereinafter called the first type data 27b) and a second type of music content data 27k (hereinafter called the second type data 27k). FIG. 3 shows an example of the first type data 27b formed by a music identifier 27c, a music content data block 27d (hereinafter called the music content 27d), a title 27e of a piece of music represented by the music content 27d, an artiste name 27f, a rating 27g, a number of playing times 27h (hereinafter shortened as the NPT 27h), a genre 27i and a total playing time 27j (hereinafter shortened as the TPT 27j).

The music identifier 27c of the example of the first type data 27b shown in FIG. 3 is “M-1”. Each of the first type data 27b may be, but not limited to, a data file attached to an email received by the email transceiver 22 and stored in the music content memory 27 as earlier described. Each of the first type data 27b may be a data file downloaded by a website browser of the mobile communication apparatus of the present invention (not shown in FIG. 1). Each of the first type data 27b may be a copy of a data file read out of a removable memory medium (not shown in FIG. 1).

The rating 27g is a rating given by an audience to the piece of music represented by the music content 27d. The rating 27g is an integer from zero to five. The NPT 27h indicates how many times the music content 27d has been played, and is given by the music content player 26 as later described. The TPT 27j indicates a total playing time of the music content 27d.

FIG. 4 shows an example of the second type data 27k formed by a playlist identifier 27m, a collective identifier 27n and a playlist name 27o. The collective identifier 27n may include and arrange at least one entry of the music identifier 27c in order. Each of the second type data 27k is a playlist identified by the playlist identifier 27m, i.e. “P-1” in the example of the second type data 27k shown in FIG. 4. The collective identifier 27n of the example of the second type data 27k shown in FIG. 4 is formed by “M-1” and “M-2”.

Each of the second type data 27k may be, but not limited to, a data file attached to an email received by the email transceiver 22 and stored in the music content memory 27 as earlier described. The main controller 11 may indicate a table of each entry of the title 27e on the display 15. The main controller 11 may form the collective identifier 27n from at least one entry of the music identifier 27c which is entered by a key operation on the operation unit 16. Each entry of the music identifier 27c corresponding to each entry of the title 27e is arranged in sequence and included in the collective identifier 27n.

The main controller 11 may give the playlist name 27o a character string representing a playlist name which is entered by a key operation on the operation unit 16. The main controller 11 may replace the playlist identifier 27m that has already been stored with a different entry. The main controller 11 may thereby form and store each of the second type data 27k.

In response to a key operation on the operation unit 16 to play a piece of music included in the music content data 27a, the main controller 11 may select the music identifier 27c and activate the music content player 26. After being activated, the music content player 26 plays the music content 27d identified by the music identifier 27c, and provides the speaker 26 with a produced sound signal while specifying a level of loudness.

The main controller 11 may select the playlist identifier 27m and activate the music content player 26. After being activated, the music content player 26 plays each (at least one) entry of the music content 27d identified by each entry of the music identifier 27c included in the collective identifier 27n in sequence, and provides the speaker 26 with a produced sound signal while specifying a level of loudness.

While playing the music content 27d, the music content player 26 may send the music information and the status information to the image content player 24. The music information includes the title 27e, the artiste name 27f, the rating 27g, the NTP 27h, the genre 27i and the TPT 27j, which are stored in association with the music content 27d that is being played.

The status information includes a playing status, a period of time counted after the music content player 26 starts playing the music content 27d, and a selectable maximum level of loudness. The playing status is one of running, pausing, fast-forwarding and rewinding. The level of loudness is represented by an integer from zero (minimum loudness) to five (maximum loudness).

In a case where the main controller 11 selects the playlist 27m and the music content player 26 plays at least one entry of the music content 27d in sequence, the music content player 26 may further inform the image content player 24 of the playlist name 27o stored in association with the playlist identifier 27m, and where (what number) the music identifier 27c corresponding to the music content 27d that is being played is in the collective identifier 27n.

What the music content player 26 deals with as described above is one of the secondary processes. While one of the primary processes is running, the main controller 11 pauses the music content player 26.

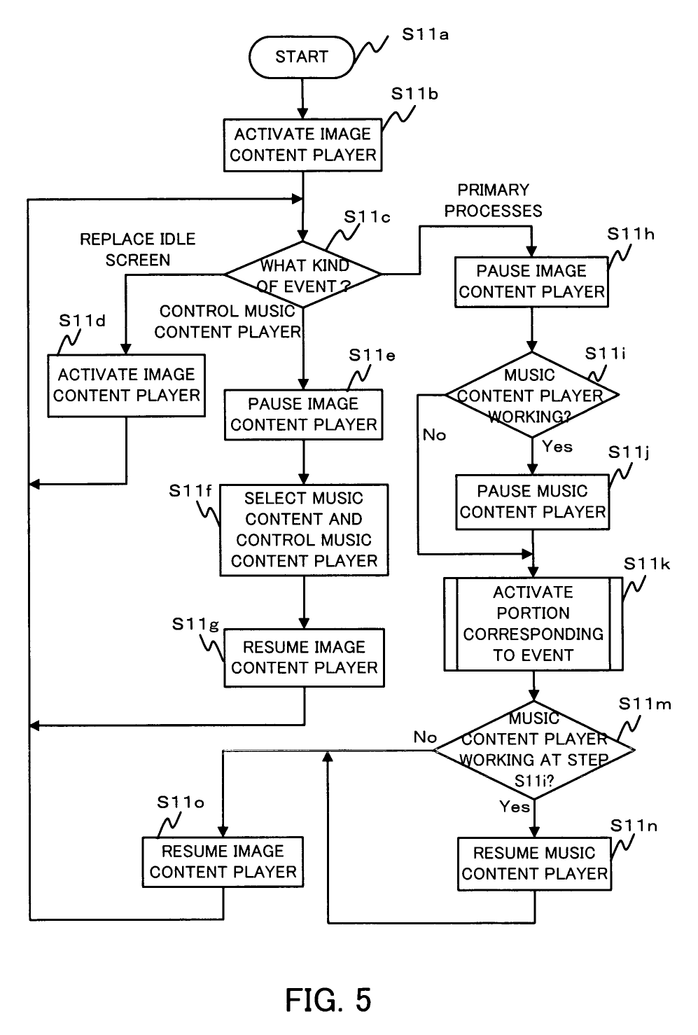

How the main controller 11 controls the primary processes and the secondary processes will be described with reference to FIG. 5, a flow chart of a method for running those processes. The main controller 11 starts the operation after a power switch of the mobile communication apparatus of the present invention (not shown in FIG. 1) is turned on (step S11a). The main controller 11 specifies one of the image content data 25a, activates the image content player 24 and presents the idle screen on the display 15 (step S11b).

In the above paragraph, the main controller 11 may specify one of the image content data 25a according to, but not limited to, a given key operation on the operation unit 16 as later described. The main controller 11 may, e.g. at the step S11b, decode an encoded static picture stored in the main controller 11 to present as the idle screen on the display 15.

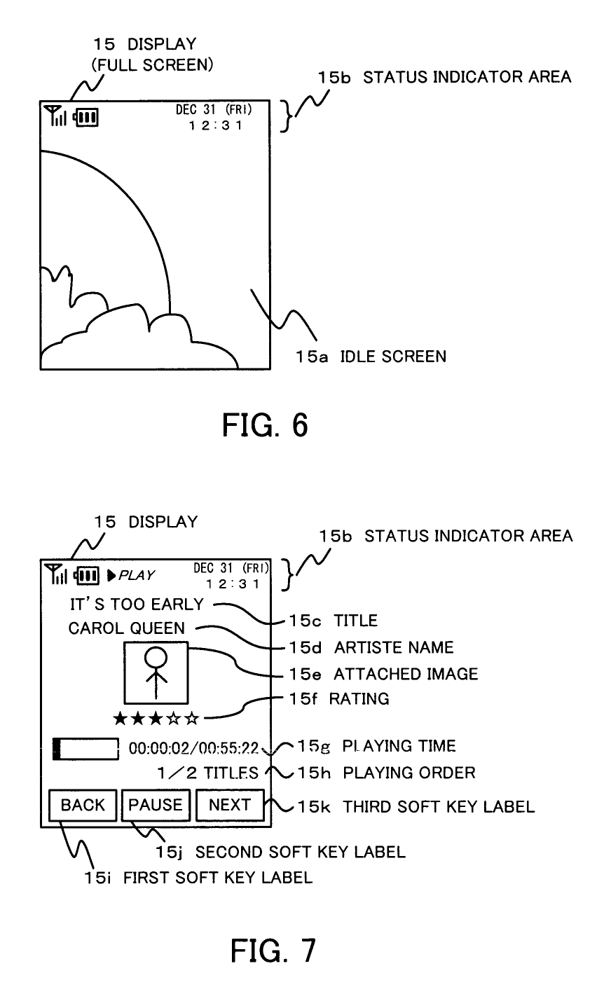

FIG. 6 shows an example of an idle screen presented on the display 15 by the image content player 24. The image content player 24 plays the image content 25c, and presents on the display 15 an idle screen 15a, i.e; a full screen on which a cloud is drawn. The idle screen 15a will be shown in other drawings of the first embodiment, and its explanation will be omitted hereafter.

A top area of the idle screen 15a is used as a status indicator area 15b where a signal strength indicator, a battery level indicator and a date and time (including a day of a week) are shown. The signal strength indicator is formed by an antenna-like symbol and a plurality of vertical bars, and shows strength of a radio signal that the radio circuit 12b receives from a base station. The battery level indicator is formed by a battery-like symbol and shows a battery charge level. The signal strength indicator, the battery level indicator and the date and time are always shown in the status indicator area 15b, and their explanations will be omitted hereafter.

The main controller 11 then determines a kind of an event that has occurred (step S11c). In a case where the event is a given key operation to replace the idle screen 15a with a different idle screen, the main controller 11 selects one of the image content data 25a representing the different idle screen and activates the image content player 24 (step S11d). In a case where the event is a given key operation to determine the format 25e, the main controller 11 selects one of the formats of the format 25e and activates the image content player 24 (step S11d). After activating the image content player 24, the main controller 11 goes back to the step S11c and waits for another event.

In a case where the event is a given key operation to control the music content player 26, the main controller 11 pauses the image content player 24 (step S11e). The above mentioned key operation to control the music content player 26 is, e.g. an operation to activate the music content player 26 and to have the music content player 26 play a piece of music, an operation to specify a playing status, an operation to finish playing the music, etc.

The main controller 11 then presents on the display 15 a given screen, e.g. a menu screen where one of the music content data 27a may be selected, a music play may be finished, etc. The main controller 11 controls the music content player 26 to select one of the music content data 27a, to play the music content 27d, etc (step S11f).

FIG. 7 shows an example of a screen on the display 15 indicating a set of information that the music content player 26 provides after being activated and starting playing the music content 27d. The screen shown in FIG. 7 is not the idle screen 15a. On the status indicator area 15b, indicated are a tip of an arrow directing right and a character string “PLAY” in addition to the indicators earlier described, in order to show that the music content player 26 is playing the music contend 27d.

While the music content player 26 pauses a play of the music content 27d, indicated is a character string “PAUSE” instead of “PLAY”. While the music content player 26 is rewinding the music content 27d, indicated is a character string “REW” instead of “PLAY”. While the music content player 26 is fast-forwarding the music content 27d, indicated is a character string “FFW” instead of “PLAY”. The playing status of the music content 27d is always indicated by one of those character strings on the status indicator area 15b while the music content player 26 works, and its explanation will be omitted hereafter.

From upper to lower on the screen shown in FIG. 7, indicated are a title 15c, an artiste name 15d, an attached image 15e, a rating 15f, a playing time 15g and a playing order 15h. In FIG. 7, e.g. the title 15c is indicated by a character string “IT'S TOO EARLY”, the artiste name 15d by a character string “CAROL QUEEN”, the attached image by a person-like object, the rating 15f is a line of star-like symbols each of which is distinguished by color, the playing time 15g by a rectangular indicator and a character string “00:00:02/00:55:22”, and the playing order 15h by a character string “1/2 TITLES”.

From left to right on a bottom of the screen shown in FIG. 7, indicated are a first soft key label 15i, a second soft key label 15j and a third soft key label 15j. In FIG. 7, the first soft key label 15i is indicated by a character string “BACK” for selecting a piece of music just before a current one, the second soft key label 15j by a character string “PAUSE”, and the third soft key label 15k by a character string “NEXT” for selecting a piece of music next to the current one.

The title 15c shows a title of a piece of music represented by the music content 27d that is being played by the music content player 26. The artiste name 15d shows an artiste name of the piece of music represented by the music content 27d that is being played by the music content player 26. The attached image 15e shows a static picture included in the first type data 27b, although not shown in FIG. 3, in association with the music content 27d that is being played by the music content player 26.

The rating 15f shows a value of the rating 27g of the music content 27d that is being played by the music content player 26. The rating 15f is formed by a line of five star-like symbols. A number equal to the rating 27g (an integer from zero to five) of the star-like symbols is shown dark, and a rest of the star-like symbols is shown bright.

The rectangular indicator included in the playing time 15g is shown bright as a whole immediately after the music content player 26 starts playing the music content 27d. The rectangular indicator is shown dark as a whole immediately before the music content player 26 finishes playing the music content 27d. While the music content 27d is being played, a left portion of the rectangular indicator is shown dark to indicate a ratio of a period of time counted after the music content player 26 starts playing the music content 27d to the total playing time 27j included in the first type data 27b in association with the music content 27d. The character string included in the playing time 15g indicates the counted period of time and the total playing time 27j, both being separated by a slash like a fraction, where the counted period of time corresponds to a numerator and the total playing time 27j corresponds to a denominator.

In a case where the main controller 11 selects the playlist identifier 27m and activates the music content player 26, the playing order 15h shows where (what number) the music identifier 27c corresponding to the music content 27d that is being played is in the collective identifier 27n. The playing order 15h shows a number of all entries of the collective identifier 27n. The number of the music identifier 27c and the number of all entries are separated by a slash like a fraction, where the number of the music identifier 27c corresponds to a numerator and the number of all entries corresponds to a denominator.

In a case where the main controller 11 selects the playlist identifier 27m and activates the music content player 26 and one of the soft keys (not shown in the drawings) of the operation unit 16 disposed closest to the first soft key label 15i is pressed, the music content player 26 plays a piece of music corresponding to an entry of the collective identifier 27n arranged immediately before the music identifier 27c.

In a case where one of the soft keys (not shown in the drawings) of the operation unit 16 disposed closest to the second soft key label 15j is pressed, the music content player 26 pauses the music content 27d.

In a case where the main controller 11 selects the playlist identifier 27m and activates the music content player 26 and one of the soft keys (not shown in the drawings) of the operation unit 16 disposed closest to the third soft key label 15k is pressed, the music content player 26 plays a piece of music corresponding to an entry of the collective identifier 27n arranged next to the music identifier 27c.

In a case where a given key of the operation unit 16 is pressed, the music content player 26 may present a list of entries of the title 27e, and may present a list of entries of the playlist name 27o, on the display 15. The music content player 26 may select the title 27e indicated by a given key operation on the operation unit 16 to start playing the music content 27d, and may select the playlist name 27o indicated by a given key operation on the operation unit 16 to start playing a piece of music corresponding to an entry of the collective identifier 27n.

In a case where a given key of the operation unit 16 is pressed, the music content player 26 may fast-forward the music content 27d, and may rewind the music content 27d. In a case where a given key of the operation unit 16 is pressed, the music content player 26 may finish working.

The main controller 11 finishes presenting a screen, e.g. like the one shown in FIG. 7, a given period of time after starting playing the music content 27d, while continuing playing the music content 27d. The main controller 11 resumes an operation of the image content player 24 to present the idle screen 15a (step S11g). The main controller 11 then goes back to the step S11c and waits for another event.

In a case where the event is associated with one of the primary processes, the main controller 11 pauses the image content player 24 (step S11h). A process of, e.g. dealing with an instruction to request a call is primary. And so are a process of dealing with an arrival of an incoming call request, a process of dealing with an instruction to send an outgoing email, and a process of dealing with an instruction to present a received email.

The main controller 11 checks if the music content player 26 is working, and keeps a result of the check (step S11i). In a case where the music content player 26 is working, the main controller 11 pauses the music content player 26 (step S11j). In a case where the music content player 26 is not working, the main controller 11 activates a portion of the mobile communication apparatus of the present invention corresponding to the event, and controls an operation of the activated portion. Meanwhile, the activated portion may present something on the display 15, and may work depending on a given key operation on the operation unit 16 (step S11k). An example of the operation of the activated portion will be described later.

After an end of the operation of the activated portion, the main controller 11 checks the result of the check at the step S11i(step S11m). In a case where the result says that the music content player 26 has been working at the step S11i, the main controller 11 resumes the music content player 26 (step S11n). In a case where the result says that the music content player 26 has not been working at the step S11i, the main controller 11 resumes the image content player 24 (step S11o). The main controller 11 then goes back to the step S11c and waits for another event.

In a case where the event is a given key operation to request a call at the step S11c, the main controller 11 activates the voice call controller 21 and runs a process of requesting a call and a voice transaction. In a case where the event is an arrival of an incoming call request received by the baseband circuit 13 at the step S11c, the main controller 11 activates the voice call controller 21 and runs a process of accepting the call request and a voice transaction.

In a case where the event is a given key operation to send an email at the step S11c, the main controller 11 activates the email transceiver 22 and runs a process of sending an email. In a case where the baseband circuit 13 receives a signal indicating an arrival of an incoming email at the step S11c, the main controller 11 activates the email transceiver 22 and runs a process of receiving the incoming email. In a case where the event is a given key operation to present a received email on the display 15 at the step S11c, the main controller 11 activates the email transceiver 22 and runs a process of presenting the received email.

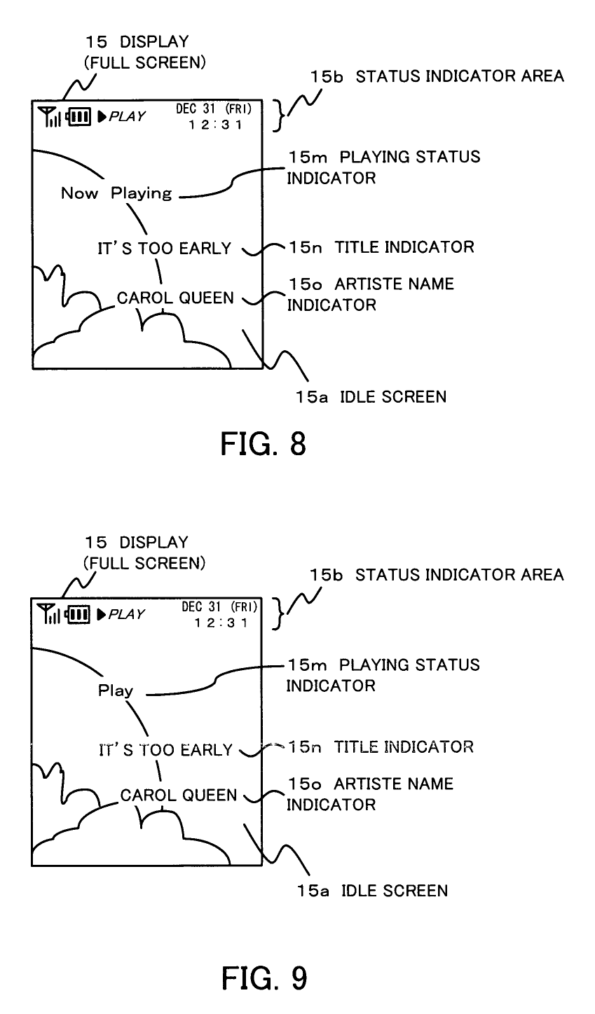

What is presented on the display 15 while the image content player 24 and the music content player 26 are working will be described as follows. FIG. 8 shows an example of what is presented on the display 15 while the image content player 24 and the music content player 26 are working, in a case where the image content player 24 presents the idle screen 15a at the step S11g shown in FIG. 5. What is shown in FIG. 8 is also presented on the display 15 in a case where the music content player 26 is working and the image content player 24 presents the idle screen 15a at the step S11o shown in FIG. 5.

The image content player 24 plays the image content 25c, and presents on the display 15 the idle screen 15a, i.e. a full screen on which a cloud is drawn. The main controller 11 presents the status indicator area 15b on a top of the idle screen 15a.

In FIG. 8, shown are on the display 15 a playing status indicator 15m near a center of the idle screen 15a, and a title indicator 15n and an artiste name indicator 15o below the center. The playing status indicator 15m is shown by a character string “Now Playing”, the title indicator 15n by a character string “IT'S TOO EARLY”, and the artiste name indicator 15o by a character string “CAROL QUEEN”. The example shown in FIG. 8 indicates that the music content 27d having the shown title and the artiste name is being played.

FIG. 9 shows an example almost similar to the example shown in FIG. 8, except that the playing status indicator 15m is shown by a character string “PLAY”. The examples given in FIG. 8 and in FIG. 9 are according to the first format of the format 25e included in the indication mode 25d shown in FIG. 2.

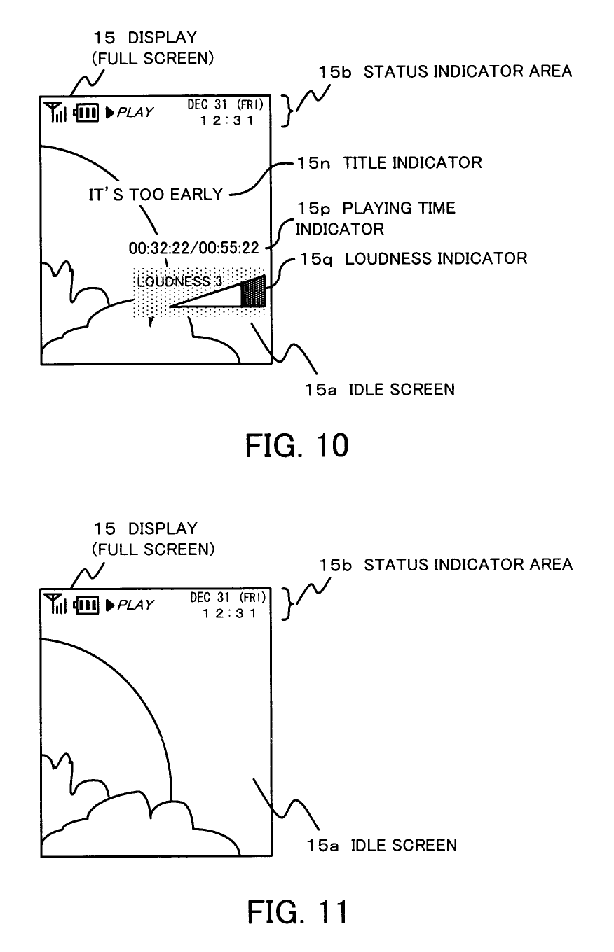

FIG. 10 shows an example including the title indicator 15n near the center, and a playing time indicator 15p and a loudness indicator 15q below the center. The title indicator 15n is shown by a character string “IT'S TOO EARLY”, and the playing time indicator 15p by a character string “00:32:22/00:55:22”. The loudness indicator 15q is formed by a character string “LOUDNESS 3” and a triangular indicator a portion of which is shown by white and a rest is shown by different color.

The playing time indicator 15p indicates that the total playing time 27j of the music content 27d that is being played is 55 minutes and 22 seconds, and that a period of time of 32 minutes and 22 seconds has passed after the music content player 26 starts playing the music content 27d. The loudness indicator 15q indicates that a loudness level is three and the triangular indicator divided by two colors indicates that the loudness level is between the maximum and the minimum. The example given in FIG. 10 is according to the second format of the format 25e included in the indication mode 25d shown in FIG. 2.

FIG. 11 shows an example formed by the idle screen 15a on which a cloud is drawn based on the image content 25c, and the status indicator area 15b. A piece of information regarding the music content 27d that the music content player 26 is playing and a playing status of the music content player 26 are indicated on the status indicator area 15b. The example given in FIG. 11 is according to the third format of the format 25e included in the indication mode 25d shown in FIG. 2.

In a case where the event that occurs at the step S11c is associated with none of the image content player 24, the music content player 26, the primary processes and voices and sounds, and is associated with, e.g. editing a directory (not shown in the drawings), the main controller 11 controls an operation of a portion of the mobile communication apparatus of the present invention corresponding to the event, and the music content player 26 continues playing the music content 27d. The above case may be handled like a case where the event is an instruction to the image content player 24.

In the case where the event is associated with the primary processes at the step S11c, the main controller 11 may not pause the music content player 26 at the step S11j. The music content player 26 may continue playing the music content 27d unless the main controller 11 runs a process associated with a voice and a sound, e.g. a voice call.

In a case where the event that occurs at the step S11c is preparing and sending an email, the music content player 26 may continue playing the music content 27d, as the event has nothing to do with a voice and a sound. In that case, a process of preparing and sending an email does not matter if the music content player 26 is working. In a case where the event that occurs at the step S11c is a process of presenting a received email, the music content player 26 may continue playing the music content 27d.

In a case where the event that occurs at the step S11c is a process of presenting an email that has been sent, the music content player 26 may continue playing the music content 27d. In a case where the event that occurs at the step S11c is a process of a browsing controller (not shown in FIG. 1) excluding a voice and a sound, the music content player 26 may continue playing the music content 27d.

In the above description, the image content player 24 and the music content player 26 each run one of the secondary processes which are almost equivalent to a task running in a background and are not directly controlled by a key operation on the operation unit 16. The loudness of the music content player 26, however, may be directly controlled by a key operation on the operation unit 16.

In the above description, the image content player 24 may pause but never stops working, and indicates the status of the music content player 26 that may stop working. A portion of the mobile communication apparatus of the present invention that may stop working is not limited to the music content player 26.

The mobile communication apparatus of the present invention may have a radio broadcast receiver (not shown in FIG. 1) receiving a radio broadcast program to provide the speaker 26a with a sound of the program and to record the sound. The radio broadcast receiver runs one of the secondary processes and may stop working. The mobile communication apparatus of the present invention may have a Bluetooth™ unit (not shown in FIG. 1) usable for a hands-free call and an exchange of music data being played. The Bluetooth™ unit runs one of the secondary processes and may stop working.

The image content player 24 may indicate a station identification and a frequency of the radio broadcast which are provided by the radio broadcast receiver. The image content player 24 may indicate if the Bluetooth™ unit works, an identification of an opposite apparatus of the data exchange with Bluetooth™, and a quality of Bluetooth radio signals, which are provided by the Bluetooth™ unit.

How to indicate the station identification of the radio broadcast and so on described above may be included in the image content data 25a in association with the image content identifier 25b, like the indication mode 25d. The image content player 24 indicates the station identification of the radio broadcast and so on accordingly. In a case where a plurality of secondary processes may run simultaneously, a way of indicating a plurality of pieces of information regarding the secondary processes may be tailored to avoid an overlap and may be included in the image content data 25a.

The first embodiment of the present invention described above may also be applied to another type of communication apparatus, and not limited to a mobile communication apparatus. According to the first embodiment of the present invention described above, a communication apparatus may smoothly run a primary process like a voice call while running a secondary process like playing a piece of music.

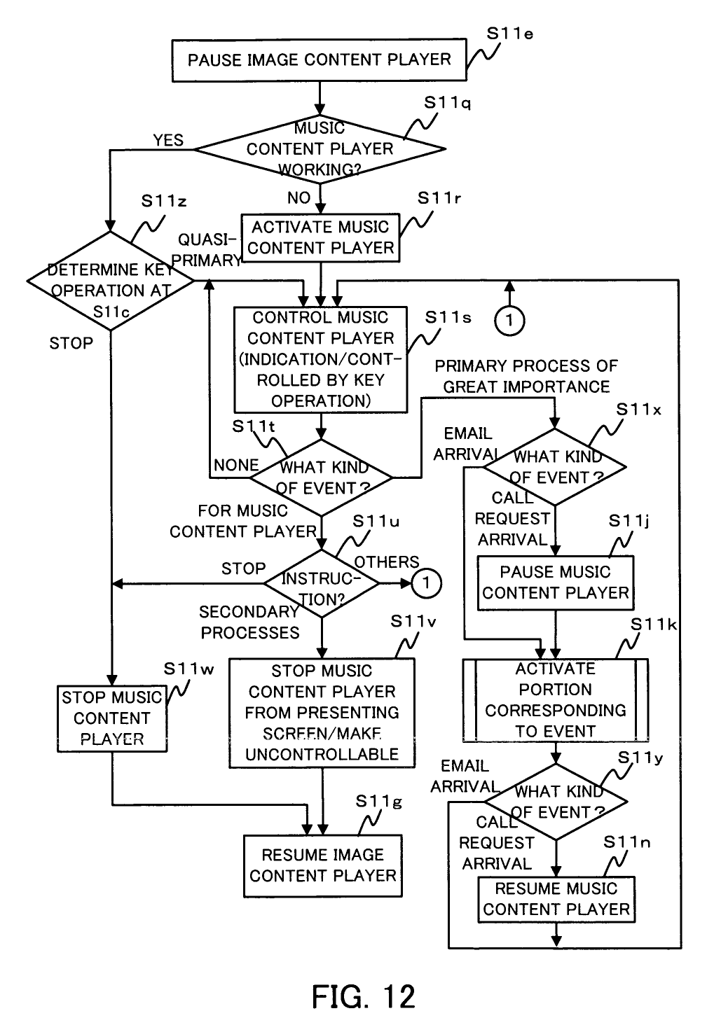

A second embodiment of the present invention will be described with reference to FIG. 12. In the second embodiment, the main controller 11 controls the primary processes and the secondary processes in a way different from that of the first embodiment. In the first embodiment, the music content player 26 runs one of the secondary processes and pauses while one of the primary processes runs. In the second embodiment, the music content player 26 may be optionally treated as a portion running so called a quasi-primary process.

That is, the music content player 26 pauses while one of the primary processes of great importance runs, but may continue working without a pause while one of the primary processes of less importance runs. In the above case where the music content player 26 continues working, the music content player 26 is directly controlled by a key operation on the operation unit 16.

The primary processes of great importance are, e.g. a process of accepting a call request, a process of receiving an incoming email, etc. The primary processes of less importance are, e.g. a process of requesting a call, a process of preparing and sending an outgoing email, a process of presenting a received email, etc.

In the second embodiment of the present invention, the main controller 11 controls the music content player 26 in a way different from that of the step S11f shown in FIG. 5 of the first embodiment. How the main controller 11 controls the primary processes and the secondary processes in the second embodiment will be described with reference to FIG. 12, a flow chart of running the above processes, focusing on a step corresponding to the step S11f shown in FIG. 5. FIG. 12 includes a plurality of steps each of which is a same as the corresponding one given the same reference numeral shown in FIG. 5, and its explanation is omitted.

The main controller 11 pauses the image content player 24 at the step S11e, and determines if the music content player 26 is working (step S11q). In a case where the music content player 26 is not working, the main controller 11 activates and then controls the music content player 26 (step S11r). The main controller 11 presents on the display 15 a given screen, e.g. a menu screen where one of the music content data 27a may be selected. The main controller 11 has the music content player 26 play the music content 27d included in the selected one of the music content data 27a (step S11s).

The step S11r and the step S11s form a same step as the step S11f shown in FIG. 5. At and after the step S11s, the music content player 26 presents the screen shown in FIG. 7. The music content player 26 is treated as a portion running a quasi-primary process, as the music content player 26 is controlled according to a given key operation on the operation unit 16.

The above term “quasi-primary” means that the music content player 26 is usually controlled as a portion running one of the secondary processes, and is exceptionally controlled as a portion running one of the primary processes. A flow from the step S11s mentioned above to a following step S11t mentioned later is treated as one of the primary processes. A transition from the step S11s mentioned above to another step of one of the secondary processes is treated as one of the primary processes.

The main controller 11 then determines a kind of an event that occurs without stopping the music content player 26 from working and from presenting the screen shown in FIG. 7 (step S11t). Before an event occurs, the main controller 11 continues controlling the music content player 26 at the step S11s and waiting for a coming event of the step S11t.

In a case where the event that occurs is a given key operation on the operation unit 16 containing an instruction for the music content player 26, e.g. to change the music content 27d that is being played, the main controller 11 determines a kind of the instruction (step S11u). A first kind of the instruction is to treat the music content player 26 as a portion running one of the secondary processes. A second kind of the instruction is to stop the music content player 26 from working. A third kind of the instruction is different from the first and the second kinds.

In a case where the instruction is of the first kind at the step S11u, the main controller 11 has the music content player 26 continue playing the music content 27d that is being played, and stop presenting the screen shown in FIG. 7. The main controller 11 makes the music content player 26 uncontrollable by a key operation on the operation unit 16 directly (step S11v). The main controller 11 moves on to the step S11g and resumes the image content player 24 to present the idle screen 15a.

In a case where the instruction is of the second kind at the step S11u, the main controller 11 stops the music content player 26 from working, and resultantly from presenting the screen shown in FIG. 7 (step S11w). The main controller 11 moves on to the step S11g and resumes the image content player 24 to present the idle screen 15a.

In a case where the instruction is of the third kind at the step S11u, i.e. to the music content player 26 entered by one of the first soft key label 15i, the second soft key label 15j, the third soft key label 15k and another given key of the operation unit 16, the main controller 11 goes back to the step S11s, and controls the music content player 26 according to a given key operation on the operation unit 16.

In a case where the event that occurs at the step S11t is one of an arrival of a call request and an arrival of an incoming email each being one of the primary processes of great importance, the main controller 11 checks if the event is an arrival of a call request of greater importance and if the event is an arrival of an incoming email of less great importance. The main controller 11 keeps a result of the above check (step S11x). In a case where the event is an arrival of a call request, the main controller 11 pauses the music content player 26 at the step S11j. In a case where the event is an arrival of an incoming email, the main controller 11 activates the email transceiver 22 and controls an operation of the email transceiver 22 based on the step S11k, without pausing the music content player 26.

The main controller 11 then checks the result of the check at the step S11x (step S11y). In a case where the result says that the event is an arrival of a call request at the step S11x, the main controller 11 resumes the music content player 26 at the step S11n. In a case where the result says that the event is an arrival of an incoming email, the main controller 11 goes back to the step S11s to control the music content player 26 and to wait for a next event without resuming the music content player 26. In a case where the event is an arrival of an incoming email, the main controller 11 presents, e.g. an envelope icon on the status indicator area 15b that notifies of the arrival of an incoming email.

In the above case where the event is an arrival of an incoming email at the step S11x, the main controller 11 may pause the music content player 26 at the step S11j and may resume the music content player 26 at the step S11n, as in the case where the event is an arrival of a call request.

In a case where the event that has occurred at the step S11t is one of an instruction to request a call, an instruction to send an email and an instruction to present a received email each being one of the primary processes but of less importance, the main controller 11 may neglect the event. The main controller 11 may regard the event as a given key operation on the operation unit 16 for controlling the music content player 26 at the step S11s.

In a case where the music content player 26 is working at the step S11q, the main controller 11 determines if the key operation at the step S11c is to treat the music content player 26 as a portion running a quasi-primary process, and if the key operation at the step S11c is to stop the music content player 26 from working (step S11z). In a quasi-primary case, the main controller 11 goes to the step S11s. As a result, the music content player 26 presents the screen shown in FIG. 7 on the display 15, and the music content player 26 is controlled according to a given key operation on the operation unit 16. That is, the music content player 26 is treated as a portion running a quasi-primary process.

In a case where the key operation at the step S11c is to stop the music content player 26 from working, the main controller 11 stops the music content player 26 from working (step S11w), and moves on to the step S11g and resumes the image content player 24 to present the idle screen 15a.

The second embodiment of the present invention described above may also be applied to another type of communication apparatus, and not limited to a mobile communication apparatus. According to the second embodiment of the present invention described above, a communication apparatus may suspend a primary process of less importance while running a secondary process, and thereby may improve flexibility of operations.

The particular hardware or software implementation of the present invention may be varied while still remaining within the scope of the present invention. It is therefore to be understood that within the scope of the appended claims and their equivalents, the invention may be practiced otherwise than as specifically described herein.

What is claimed is:

1. A communication apparatus capable of running a secondary process in addition to a primary process of communication, comprising:
a communication circuit configured to send and receive a plurality of signals for communication;
a first controller coupled to the communication circuit and configured to run the primary process using the communication circuit;
a second controller configured to run the secondary process;
a display; and
a display controller coupled to the first controller, the second controller and the display, the display controller being configured to receive a piece of information regarding operation of the second controller from the second controller, the display controller being configured to present a given screen on the display including the information received from the second controller, the display controller being configured to pause if the first controller starts running the primary process.

2. The communication apparatus of claim 1, wherein the first controller is further configured to start running the primary process if the communication circuit receives one of the signals for communication indicating an arrival of a piece of incoming information.

3. The communication apparatus of claim 1, further comprising an operation unit formed by a plurality of keys, wherein the first controller is further coupled to the operation unit, and further configured to start running the primary process if at least one of the keys is pressed according to a given procedure.

4. The communication apparatus of claim 1, wherein the second controller is further configured to pause if the first controller starts running the primary process.

5. A mobile communication apparatus capable of running a secondary process in addition to a primary process of mobile communication, comprising:
a communication circuit configured to send and receive a plurality of radio signals for mobile communication;
a first controller coupled to the communication circuit and configured to run the primary process using the communication circuit;
a second controller configured to run the secondary process;
a display; and
a display controller coupled to the first controller, the second controller and the display, the display controller being configured to receive a piece of information regarding operation of the second controller from the second controller, the display controller being configured to present an idle screen on the display including the information received from the second controller, the display controller being configured to pause if the first controller starts running the primary process.

6. The mobile communication apparatus of claim 5, wherein the first controller is further configured to start running the primary process if the communication circuit receives one of the radio signals for mobile communication indicating an arrival of a piece of incoming information.

7. The mobile communication apparatus of claim 5, wherein the first controller is further configured to start running the primary process if the communication circuit receives one of the radio signals for mobile communication indicating an arrival of one of a call request and an incoming email.

8. The mobile communication apparatus of claim 5, further comprising an operation unit formed by a plurality of keys, wherein the first controller is further coupled to the operation unit, and further configured to start running the primary process if at least one of the keys is pressed according to a given procedure.

9. The mobile communication apparatus of claim 5, wherein the second controller is further configured to pause if the first controller starts running the primary process.

10. A mobile communication apparatus capable of playing a piece of music in addition to running a process of mobile communication, comprising:
a communication circuit configured to send and receive a plurality of radio signals for mobile communication;
a first controller coupled to the communication circuit and configured to run the process of mobile communication using the communication circuit;
a memory configured to store a plurality of content data representing a piece of music;
a second controller coupled to the memory, the second controller being configured to read the content data out of the memory and to play the piece of music:
a display; and
a display controller coupled to the first controller, the second controller and the display, the display controller being configured to receive a piece of information regarding operation of the second controller from the second controller, the display controller being configured to present an idle screen on the display including the information received from the second controller, the display controller being configured to pause if the first controller starts running the process of mobile communication.

11. The mobile communication apparatus of claim 10, wherein the first controller is further configured to start running the process of mobile communication if the communication circuit receives one of the radio signals for mobile communication indicating an arrival of a piece of incoming information.

12. The mobile communication apparatus of claim 10, wherein the first controller is further configured to start running the process of mobile communication if the communication circuit receives one of the radio signals for mobile communication indicating an arrival of one of a call request and an incoming email.

13. The mobile communication apparatus of claim 10, further comprising an operation unit formed by a plurality of keys, wherein the first controller is further coupled to the operation unit, and further configured to start running the process of mobile communication if at least one of the keys is pressed according to a given procedure.

14. The mobile communication apparatus of claim 10, wherein the second controller is further configured to pause if the first controller starts running the process of mobile communication.

15. The mobile communication apparatus of claim 10, wherein the second controller is further configured to read a piece of accompanying information included in the content data out of the memory, and the display controller is further configured to receive the accompanying information from the second controller, and further configured to present the accompanying information included on the idle screen.

16. The mobile communication apparatus of claim 10, further comprising a speaker, wherein the second controller is further configured to provide the speaker with a sound signal produced by playing the piece of music.

17. The communication apparatus of claim 1, wherein the information regarding operation of the second controller includes information regarding the secondary process or information regarding a status of the second controller.

18. The mobile communication apparatus of claim 5, wherein the information regarding operation of the second controller includes information regarding the secondary process or information regarding a status of the second controller.

19. The mobile communication apparatus of claim 10, wherein the information regarding operation of the second controller includes information regarding the piece of music or information regarding a status of the second controller.
